(19) United States
(12) Patent Application Publication
(10) Pub. No.: US 2017/0294241 A1
(43) Pub. Date: Oct. 12, 2017

(54) CORROSION REDUCTION IN A MOLTEN SALT REACTOR

(71) Applicant: Elysium Industries Limited, Vancouver (CA)

(72) Inventors: Andrew McCall Dodson, Malden, MA (US); Michael Simpson, Salt Lake City, UT (US); William Wangard, Boston, MA (US); Edward Pheil, Delanson, NY (US)

(21) Appl. No.: 15/342,513

(22) Filed: Nov. 3, 2016

Related U.S. Application Data
(60) Provisional application No. 62/251,365, filed on Nov. 5, 2015.

(51) Int. Cl. G21C 1/32; B01J 19/00; C23F 13/16; C23F 15/00; H01M 4/02; G21C 1/22; B01J 19/02

(52) U.S. Cl. CPC G21C 1/322; G21C 1/22; B01J 19/0013; B01J 19/02; C23F 15/00; H01M 4/02; C23F 13/16

(57) ABSTRACT

A molten salt reactor comprising a reactor vessel and a molten salt contained within the reactor vessel. There is a corrosion reduction unit configured to process the molten salt to maintain an oxidation reduction ratio, (E(o)/E(r)), in the molten salt at a substantially constant level, wherein E(o) is an element (E) at a higher oxidation state (o) and E(r) is the element (E) at a lower oxidation state (r).

### FIELD OF INVENTION

The present invention relates generally to molten salt nuclear reactors and more specifically to corrosion reduction in a molten salt nuclear reactor.

### BACKGROUND

To improve on previous Light Water Reactor (LWR) technologies, Molten Salt Reactors (MSRs) have been researched since the 1950s. MSRs are a class of nuclear fission reactors in which the primary coolant, or even the fuel itself, is a molten salt mixture (e.g., fluoride or chloride salt). Compared to LWRs, MSRs offer projected lower per-kilowatt hour (kWh) levelized cost, comparatively benign fuel and waste inventory composition, highly efficient fuel utilization, and a combination of higher accident resistance with lower worst-case accident severity (due to more benign inventory composition). In various designs, the innate physical properties of MSRs passively and indefinitely remove decay heat and bind fission products.

Early development of MSRs was primarily from the 1950s to 1970s, but a renewed interest in MSRs has recently been developed. However, since less development effort has been devoted to MSRs than to other reactor types, various technical challenges remain to be solved in order to develop a commercially viable system. One of the challenges impeding the design and development of MSRs is the corrosion of the reactor structure in contact with the molten salt. In an MSR, uranium and other metallic system components are exposed to a corrosive environment. Salt exists in a multiple of valence states (e.g. UCl₃, UCl₄). This makes the bulk salt potentially corrosive to metals in the MSR components (e.g. core vessel, heat exchangers, and piping). Alloying elements in high temperature metal alloys commonly used to construct MSR components have a high solubility in molten salts and thus corrode quickly. Such corrosion damages the interior surface of the components and reduces their life.

Previously, researchers have been focused on development of new materials that are more resistive to this type of corrosion. Early studies identified Hastelloy-N as a promising candidate to construct MSR components (ORNL design document, Conceptual Design Characteristics of a Denatured Molten-salt Reactor with Once-Through Fueling, p. 86.). More recently, new types of materials, such as Carbon fiber-reinforced carbon composites (C/C) and silicon carbide matrix (SiC/SiC) have also emerged as promising materials (Hille et al., Nuclear Engineering and Design, 251:222-229, 2012; Xu, TMSR Project at SINAP, International Thorium Energy Organization Conference, 2012). However, long-term experience with a production scale reactor has yet to be gained and materials for a high temperature (e.g., over 700° C.) have not been validated. With unsolved challenges in reducing the corrosion of MSR components during nuclear fission, an alternative method to achieve this goal is highly desired.

### SUMMARY

It is therefore an object of the invention to provide an effective, efficient, and economical solution to reduce corrosion in molten salt nuclear reactors.

In one aspect of the present invention, a molten salt reactor is disclosed having a reactor vessel and a molten salt contained within the reactor vessel. There is a corrosion reduction unit configured to process the molten salt to maintain an oxidation reduction ratio, (E(o)/E(r)), in the molten salt at a substantially constant level, wherein E(o) is an element (E) at a higher oxidation state (o) and E(r) is the element (E) at a lower oxidation state (r).

In other aspects of the invention one or more of the following features may be included. The element (E) may be an actinide and the actinide may be uranium (U). The uranium at the higher oxidation state may be U(IV) and the uranium at the lower oxidation state may be U(III). The U(III) may be in the form of uranium trichloride (UCl₃) and the U(IV) may be in the form of uranium tetrachloride (UCl₄). The oxidation reduction ratio (E(o)/E(r)) may be at a level between 1/20 to 1/2000. The oxidation reduction ratio (E(o)/E(r)) may be approximately 1/2000. The corrosion reduction unit may comprise a chamber having a first opening in communication with the reactor vessel through which the molten salt from the reaction vessel enters the chamber and a second opening through which the molten salt exits the chamber. There may be a first electrode disposed within the chamber including a sacrificial material which comprises at least one type of actinide. The corrosion reduction may further include a second electrode disposed within the chamber that is electrically connected to the first electrode and a controller electrically connected to the first and second electrodes to control the potential difference between the first and second electrodes. The corrosion reduction unit may further comprise a reference electrode in the chamber to detect the potential difference between the first electrode and the molten salt. The controller may be configured to apply a potential difference between the first electrode and second electrode to maintain the oxidation reduction ratio, (E(o)/E(r)) in the molten salt at the substantially constant level. The corrosion reduction unit may further include an ammeter connected between the first electrode and the controller to detect a reaction rate of the sacrificial material. The controller may be configured to compare the detected reaction rate to a target reaction rate and to apply the potential difference between the first electrode and the second electrode based on the comparison of the detected reaction rate to the target reaction rate.

In yet other aspects, the first electrode may be an anode and the actinide may be uranium. The second electrode may be a cathode. The reference electrode may comprise silver metal (Ag) in contact with AgCl. The first electrode may be an anode and the actinide may be uranium. The substance generated through the reaction of the first electrode and the molten salt may comprise uranium trichloride (UCl₃). There may further be included a first line interconnecting the reactor vessel to the first opening of the chamber and a second line interconnecting the second opening of the chamber to the reactor vessel. There may also be included a pump to transport the molten salt from the reactor vessel to the chamber through the first line and from the chamber to the reactor vessel through the second line. The reactor vessel may comprise a metallic alloy. The metallic alloy may comprise iron (Fe), nickel (Ni), chromium (Cr), manganese (Mn), carbon (C), silicon (Si), niobium (Nb), titanium (Ti), vanadium (V), phosphorus (P), sulfur (S), molybdenum (Mo) or nitrogen (N). The molten salt may comprise a fissile material including thorium (Th), protactinium (Pa), uranium (U), neptunium (Np), Plutonium (Pu), Americium (Am), Curium (Cm). The fissile material may comprise Th-225, Th-227, Th-229, Pa-228, Pa-230, Pa-232, U-231, U-233, U-235, Np-234, Np-236, Np-238, Pu-237, Pu-239, Pu-241, Am-240, Am-242, Am-244, Cm-243, Cm-245, Cm-247. The molten salt may further comprise a carrier salt including sodium (Na), calcium (Ca), and/or potassium (K). The molten salt may further comprise a one or more of the following: ThC1₄, UCl₃, NaCl, CaC1₂, UCl₄, and KCl. The chamber may comprise a third opening on a top surface of the chamber, the third opening configured to enable insertion into and removal from the chamber of the first electrode and the reference electrode when replacement is required to due consumption of sacrificial material.

In further aspects of the invention there is included a reactor vessel and a molten salt contained within the reactor vessel. There is a corrosion reduction unit configured to reduce corrosion of the reactor. The corrosion reduction unit comprises a chamber having a first opening in communication with the reactor vessel through which the molten salt from the reactor vessel enters the chamber and a second opening through which the molten salt exits the chamber. There is a first electrode disposed within the chamber including a sacrificial material which comprises at least one type of actinide.

In an additional aspect of the invention there is a corrosion reduction module configured to reduce corrosion in a reactor vessel containing a molten salt. The corrosion reduction module comprises a chamber having a first opening configured to receive the molten salt from the reactor vessel and a second opening through which the molten salt exits the chamber. There is a corrosion reduction device configured to process the molten salt to maintain an oxidation reduction ratio, (E(o)/E(r)), in the molten salt at a substantially constant level, wherein E(o) is an element (E) at a higher oxidation state (o) and E(r) is the element (E) at a lower oxidation state (r).

In still a further aspect of this invention, there is included a corrosion reduction module configured to reduce corrosion in a reactor vessel containing a molten salt. The corrosion reduction module comprising a chamber having a first opening configured to receive the molten salt from the reactor vessel and a second opening through which the molten salt exits the chamber. There is a first electrode disposed within the chamber including a sacrificial material which comprises at least one type of actinide.

In another aspect of the invention, there is included a method for reducing corrosion in a molten salt reactor. The method includes providing a reactor vessel and a molten salt contained within the reactor vessel. The method includes processing the molten salt to maintain an oxidation reduction ratio, (E(o)/E(r)), in the molten salt at a substantially constant level, wherein E(o) is an element (E) at a higher oxidation state (o) and E(r) is the element (E) at a lower oxidation state (r).

In other aspects of the invention one or more of the following features may be included. The element (E) may be an actinide and the actinide may be uranium (U). The uranium at the higher oxidation state may be U(IV) and the uranium at the lower oxidation state may be U(III). The U(III) may be in the form of uranium trichloride (UCl₃) and the U(IV) may be in the form of uranium tetrachloride (UCl₄). The oxidation reduction ratio (E(o)/E(r)) may be at a level between 1/20 to 1/2000. The oxidation reduction ratio (E(o)/E(r)) may be approximately 1/2000. The method may further comprise providing a chamber having a first opening in communication with the reactor vessel through which the molten salt from the reaction vessel enters the chamber and a second opening through which the molten salt exits the chamber. The method may also include disposing a first electrode within the chamber including a sacrificial material which comprises at least one type of actinide. The method may also include disposing a second electrode within the chamber that is electrically connected to the first electrode and controlling the potential difference between the first and second electrodes. The method may also include using a reference electrode in the chamber to detect the potential difference between the first electrode and the molten salt. The step of controlling may include applying a potential difference between the first electrode and second electrode to maintain the oxidation reduction ratio, (E(o)/E(r)), in the molten salt at the substantially constant level.

In other aspects of the invention one or more of the following features may be included. The method may further include providing an ammeter connected between the first electrode and the controller to detect a reaction rate of the sacrificial material. The step of controlling may include comparing the detected reaction rate to a target reaction rate and applying the potential difference between the first electrode and the second electrode based on the comparison of the detected reaction rate to the target reaction rate. The first electrode may be an anode and the actinide may be uranium. The second electrode may be a cathode. The reference electrode may comprise silver metal (Ag) in contact with AgCl. The first electrode may be an anode and the actinide may be uranium. The substance generated through the reaction of the first electrode and the molten salt may comprise uranium trichloride (UCl₃). The method may further comprise interconnecting the reactor vessel to the first opening of the chamber with a first line and interconnecting the second opening of the chamber to the reactor vessel with a second line. The method may additionally include pumping the molten salt from the reactor vessel to the chamber through the first line and from the chamber to the reactor vessel through the second line.

In yet other aspects of the invention, one or more of the following features may be included. The reactor vessel may comprise a metallic alloy and the metallic alloy may comprise iron (Fe), nickel (Ni), chromium (Cr), manganese (Mn), carbon (C), silicon (Si), niobium (Nb), titanium (Ti), vanadium (V), phosphorus (P), sulfur (S), molybdenum (Mo) or nitrogen (N). The molten salt may comprise a fissile material including thorium (Th), protactinium (Pa), uranium (U), neptunium (Np), Plutonium (Pu), Americium (Am), Curium (Cm). The fissile material may comprise Th-225, Th-227, Th-229, Pa-228, Pa-230, Pa-232, U-231, U-233, U-235, Np-234, Np-236, Np-238, Pu-237, Pu-239, Pu-241, Am-240, Am-242, Am-244, Cm-243, Cm-245, Cm-247. The molten salt may further comprise a carrier salt including sodium (Na), calcium (Ca), and/or potassium (K). The molten salt may also comprise a one or more of the following: ThC1₄, UCl₃, NaCl, CaC1₂, UCl₄, and KCl. The method may further comprise providing a third opening on a top surface of the chamber and removing from the chamber the first electrode and the reference electrode when replacement is required to due consumption of sacrificial material and inserting a replacement first electrode and a replacement reference electrode.

In yet a further aspect of the invention, there is included a method for reducing corrosion in a molten salt reactor. The method includes providing a reactor vessel and a molten salt contained within the reactor vessel. The method also includes providing a chamber having a first opening in communication with the reactor vessel and flowing the molten salt from the reactor vessel through the first opening and through the chamber. The method includes causing the molten salt to exit the chamber through a second opening and disposing a first electrode within the chamber including a sacrificial material which comprises at least one type of actinide.

### DESCRIPTION OF DRAWINGS

FIG. 1 is a schematic diagram depicting a molten salt reactor system.

FIG. 2 is a schematic diagram depicting the chemical processing plant of the molten salt reactor system depicted in FIG. 1.

FIG. 3 is a cross-sectional view of a corrosion reduction unit according to one embodiment this invention.

FIG. 4 is a flow chart of the operation of the control system of the corrosion reduction unit of FIG. 3.

FIG. 5 is a cross-sectional view of a corrosion reduction unit according to another embodiment of this invention.

FIG. 6 is a cross-sectional view of a corrosion reduction unit according to yet another embodiment of this invention.

### DETAILED DESCRIPTION

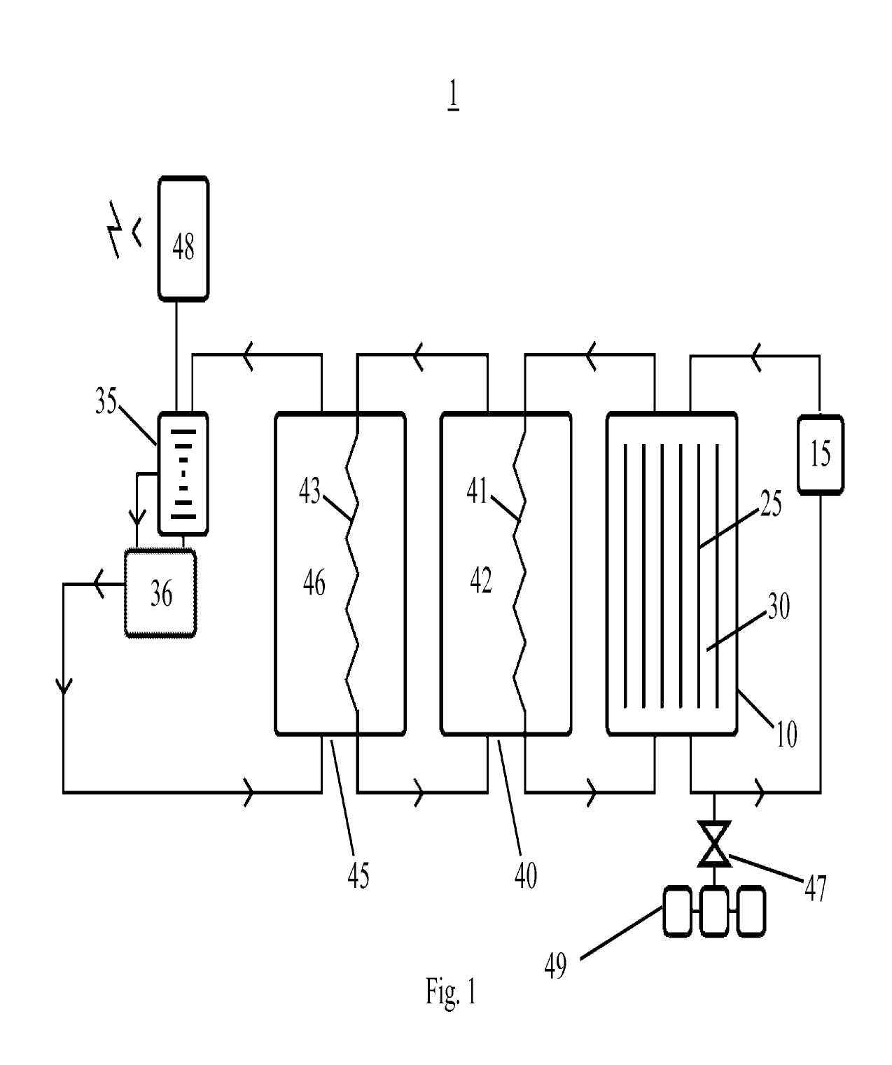

In a preferred embodiment, a molten salt reactor system 1 for the generation of electrical energy from nuclear fission is depicted in FIG. 1. System 1 includes a molten salt reactor 10, containing molten salt 30 which may include a mixture of chloride and fluoride salts. The mixture may comprise fissile materials, including thorium (Th), protactinium (Pa), uranium (U), neptunium (Np), Plutonium (Pu), Americium (Am), Curium (Cm) (more specifically Th-225, Th-227, Th-229, Pa-228, Pa-230, Pa-232, U-231, U-233, U-235, Np-234, Np-236, Np-238, Pu-237, Pu-239, Pu-241, Am-240, Am-242, Am-244, Cm-243, Cm-245, Cm-247), and fertile materials, such as Th₂₃₂C1₄, U₂₃₈Cl₃ and U₂₃₈C1₄. In this embodiment, the mixture comprises fissile materials including UCl₃, UCl₄ and ThC1₄, and carrier salts including sodium chloride (NaCl), potassium chloride (KC1), and/or calcium chloride (CaC1₂).

Upon absorbing neutrons, nuclear fission may be initiated and sustained in the fissile molten salt 30, generating heat that elevates the temperature of the molten salt 30 to, e.g. approximately 650° C.≈1,200° F. The heated molten salt 30 is transported via a pump (not shown) from the molten salt reactor 10 to a heat exchange unit 40, which is configured to transfer the heat generated by the nuclear fission from the molten salt 30.

The transfer of heat from salt 30 may be realized in various ways. For example, the heat exchange unit 40 may include a pipe 41, through which the heated molten salt 30 travels, and a secondary fluid 42 (e.g., a coolant salt) that surrounds the pipe and absorbs heat from the molten salt 30. Upon heat transfer, the temperature of the molten salt 30 is reduced in the heat exchange unit 40, and the molten salt 30 is transported from the heat exchange unit 40 back to the molten salt reactor 10. A secondary heat exchange unit 45 may be included to transfer heat from the secondary fluid 42 to a tertiary fluid 46 (e.g., water), as fluid 42 is circulated through secondary heat exchange unit 45 via pipe 43.

The heat received from the molten salt 30 may be used to generate power (e.g., electric power) using any suitable technology. For example, the water in the secondary heat exchange unit 45 is heated to a steam and transported to a turbine 35. The turbine 35 is turned by the steam and drives an electrical generator 48 to produce electricity. Steam from the turbine 35 is conditioned by an ancillary gear 36 (e.g., a compressor, a heat sink, a pre-cooler or a recuperator) and transported back to the secondary heat exchange unit 45.

Alternatively, the heat received from the molten salt 30 may be used in other applications such as nuclear propulsion (e.g., marine propulsion), desalination, domestic or industrial heating, hydrogen production, or a combination thereof

During the operation of the molten salt reactor 10, fission products will be generated in the molten salt 30. The fission products will include a range of elements. In this preferred embodiment, the fission products may include, but are not limited to, rubidium (Rb), strontium (Sr), cesium (Cs), barium (Ba), an element selected from lanthanides, palladium (Pd), ruthenium (Ru), silver (Ag), molybdenum (Mo), niobium (Nb), antimony (Sb), technetium (Tc), Xenon (Xe) or Krypton (Kr).

The buildup of fission products (e.g., radioactive noble metals and radioactive noble gases) in molten salt 30 may impede or interfere with the nuclear fission in the molten salt reactor 10 by poisoning the nuclear fission. For example, xenon-135 and samarium-149 have a high neutron absorption capacity, and may lower the reactivity of the molten salt. Fission products may also reduce the useful lifetime of the molten salt reactor 10 by clogging components, such as heat exchangers or piping.

Therefore, it is generally necessary to keep concentrations of fission products in the molten salt 30 below certain thresholds to maintain proper functioning of the reactor 10. This may be accomplished by a chemical processing plant 15 configured to remove at least a portion of fission products generated in the molten fuel salt 30 during nuclear fission. During operation, molten salt 30 is transported from the molten salt reactor 10 to the chemical processing plant 15, which may processes the molten salt 30 so that the molten salt reactor 10 functions without loss of efficiency or degradation of components. An actively cooled freeze plug 47 is included and configured to allow the molten salt 30 to flow into a set of emergency dump tanks 49 in case of power failure or on active command.

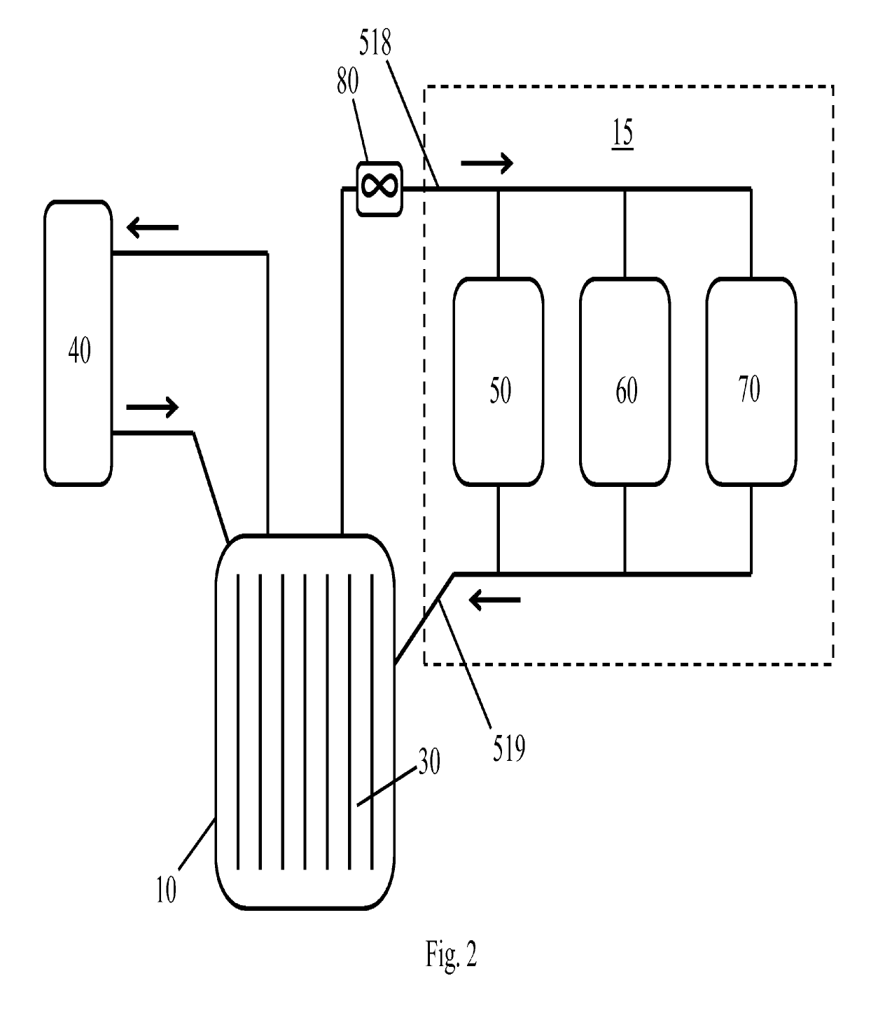

FIG. 2 shows additional detail of the chemical processing plant 15. The molten salt 30 is circulated continuously (or near-continuously) by way of pump 80 from the molten salt reactor 10 through the chemical processing plant 15. In addition to removing fission products, the chemical processing plant 15 is also configured to limit or reduce the corrosion of the molten salt reactor 10 by the molten salt 30 by way of a corrosion reduction unit 50, FIG. 2.

The chemical processing plant 30 also includes a froth floatation unit 60 configured to remove at least part of the insoluble fission products (e.g., krypton (Kr), Xenon (Xe), palladium (Pd), ruthenium (Ru), silver (Ag), molybdenum (Mo), niobium (Nb), antimony (Sb), technetium (Tc)) from molten salt 30. Froth floatation unit 60 is also configured to remove at least part of the dissolved gas fission products (e.g., Xenon (Xe) or Krypton (Kr)). The froth floatation unit 60 generates froth from the molten salt 30 that includes insoluble fission products and dissolved gas fission products. The dissolved gas fission products are removed from the froth, and at least a portion of the insoluble fission products are removed by filtration.

Also included in chemical processing plant 15 is salt exchange unit 70 which is configured to remove at least a portion of the fission products (e.g., rubidium (Rb), strontium (Sr), cesium (Cs), barium (Ba) or an element selected from lanthanides) soluble in the molten salt 30. The removal of soluble fission products may be realized through various mechanisms.

As indicated above, in order to limit corrosion of the molten salt reactor 10, the chemical processing plant 15 includes a corrosion reduction unit 50 configured to protect the corrosion of the molten salt reactor 10 by the molten salt 30. The molten salt reactor 10 is typically constructed of metallic alloy including one or more of the following elements: iron (Fe), nickel (Ni), chromium (Cr), manganese (Mn), carbon (C), silicon (Si), niobium (Nb), titanium (Ti), vanadium (V), phosphorus (P), sulfur (S), molybdenum (Mo) or nitrogen (N). The molten salt 30 may include uranium tetrachloride (UCl₄) that will corrode the molten salt reactor 10 by oxidizing chromium (Cr→Cr³⁺+3e−; Cr+3UCl₄→CrC1₃+3UCl₃).

During the nuclear fission, the molten salt 30 is transported from the reactor 10 to the corrosion reduction unit 50 and from the corrosion reduction unit 50 back to the reactor 10. The transportation of the molten salt 30 may be driven by pump 80 which may be configured to adjust the rate of transportation. The corrosion reduction unit 50 is configured to process the molten salt 30 to maintain an oxidation reduction (redox) ratio, E(o)/E(r), in the molten salt 30 in the molten salt reactor 10 (and elsewhere throughoutthe system) at a substantially constant level, wherein E(o) is an element (E) at a higher oxidation state (o) and E(r) is the element (E) at a lower oxidation state (r). In a preferred embodiment, the element (E) may be an actinide (e.g., uranium (U)) and E(o) is U(IV) and E(r) is U(III). In this embodiment, U(IV) is in the form of uranium tetrachloride (UCl₄), U(III) is in the form of uranium trichloride (UCl₃), and the redox ratio is a ratio E(o)/E(r) of UCl₄/UCl₃. Although UCl₄ corrodes the molten salt reactor 10, the existence of UCl₄ reduces the melting point of the molten salt 30. Therefore, the level of the redox ratio, UCl₄/UCl₃, may be selected based on the desired corrosion reduction and the desired melting point of the molten salt 30. For example, the redox ratio may be at a substantially constant ratio selected between 1/50 and 1/2000. More specifically, the redox ratio maybe at a substantially constant level of 1/2000.

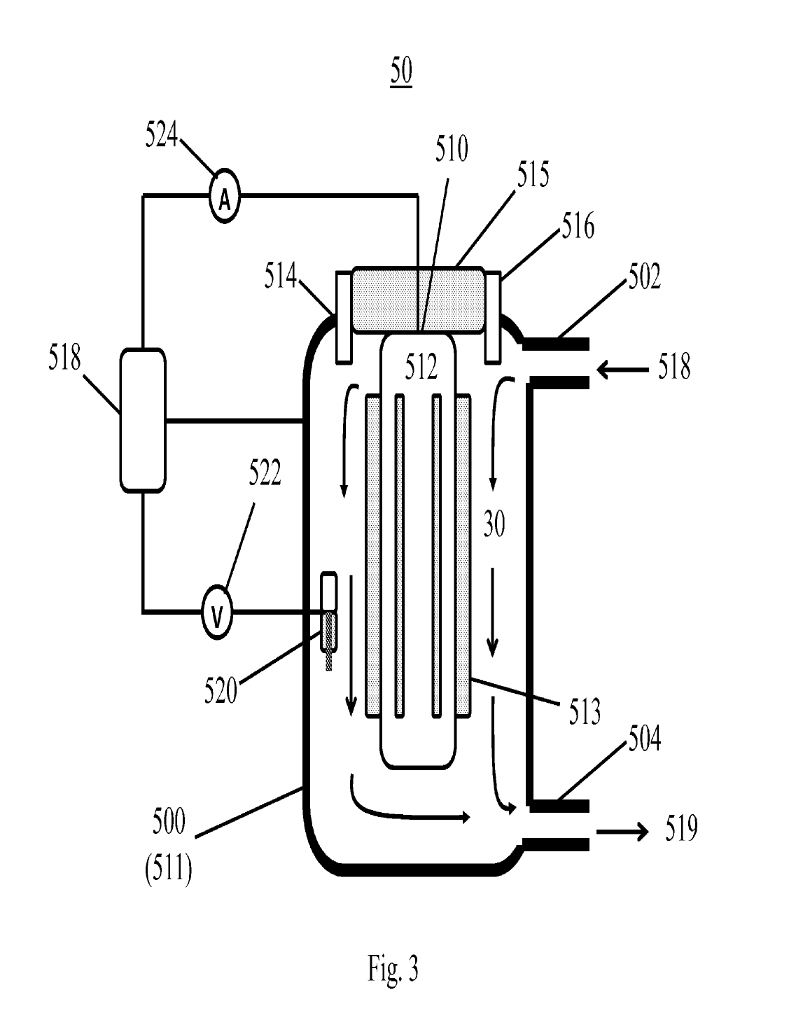

FIG. 3 illustrates a preferred embodiment of the corrosion reduction unit 50. The corrosion reduction unit 50 includes a chamber 500 having a first opening 502 in communication with the molten salt reactor 10, through which the molten salt 30 from the molten salt reactor 10 enters. The chamber 500 also includes a second opening 504, through which the molten salt 30 exits the chamber 500. The molten salt reactor 10 further includes a first line 518 to transport the molten salt 30 from the molten salt reactor 10 to the first opening 502, and a second line 519 to transport the molten salt 30 from the second opening 504 back to the molten salt reactor 10.

A first electrode 510 having a sacrificial material 512 is disposed within the chamber 500 and electrically connected to a second electrode 511 (e.g., the chamber 500). The sacrificial material comprises an actinide and preferably the actinide is uranium. Upon entering the chamber 500, the molten salt 30 is in contact with the sacrificial material 512 and preferably reacts with the sacrificial material 512. During the reaction, electrons travel between the first electrode 510 and the second electrode 511. The first electrode 510 may further include at least one fin 513 configured to increase the surface area of the first electrode 510 and the sacrificial material 512. The increased surface area may increase the contact area of the sacrificial material 512 with the molten salt 30 and facilitate the redox reaction between them.

In this embodiment, the first electrode 510 is an anode and the sacrificial material 512 is composed of uranium (e.g., U-238). The molten salt 30 preferably oxidizes the uranium in the sacrificial material 512 (U→U³⁺+3e−; U+3UCl₄→4UCl₃). The oxidation of uranium in the sacrificial material 512 generates uranium trichloride (UCl₃), which is a soluble and existing substance in the molten salt 30. Electrons generated through the oxidation of the sacrificial material 512 travel from the first electrode 510 to the second electrode 511 (the chamber 500).

During the process, UCl₄ in the molten salt 30 is reduced to generate UCl₃ (U⁴⁺+e−→U³⁺; U+3UCl₄→4UCl₃), and the redox ratio of U(IV)/U(III) (e.g., UCl₄/UCl₃) in the molten salt 30 is reduced. Therefore, the redox ratio of U(IV)/U(III) (e.g., UCl₄/UCl₃) in the molten salt 30 proximate the second opening 504 may be equal or lower than the redox ratio in the molten salt 30 proximate the first opening 502. The molten salt 30 with reduced redox ratio is then transported back to the molten salt reactor 10. As U(IV) (e.g., UCl₄) is continuously generated in the molten salt 30, the overall redox ratio in the molten salt 30 in the molten salt reactor 10 (and elsewhere throughout the system) is maintained at a substantially constant level.

Since the sacrificial material 512 is reacted to generate soluble substances in the molten salt 30 during the protection of the molten salt reactor 10, it may be desirable to replace the first electrode 510 upon consumption of the sacrificial material 512. Shown in FIG. 3, the corrosion reduction unit 50 includes a third opening 514 having a cover 515, configured to enable insertion of the first electrode 510 into the chamber 500 and removal of the first electrode 510 from the chamber 500. The cover 515 is preferably constructed with the same material of the chamber 500. An insulating material 516 seals the space between the closed cover 515 and the third opening 514. The third opening 514 may be configured to allow access to the first electrode 510 during the nuclear fission, but with isolation of the corrosion reduction unit 50 (e.g., the third opening 514 is disposed on the top surface of the chamber 500). The insertion or removal of the electrode 510 may be performed by a robotic arm when the sacrificial material has been consumed.

A reference electrode 520 (e.g., a silver (Ag) in contact with a silver chloride (AgCl)) is disposed proximate the first electrode 510 to detect the potential of the first electrode 510 (relative to the reference electrode 520). The detection is achieved by a voltmeter 522 electrically connected to the reference electrode 520 and the first electrode 510). A controller 518 is electrically connected to the first electrode 510 and the second electrode 511, and is configured to control the potential difference between the electrodes and thus control the reaction rate of the sacrificial material 512 of the first electrode 510. An ampere-meter ammeter 524 is electrically connected to the first electrode and configured to measure the flow rate of electrons (e.g., current) from the first electrode 510 to the second electrode 511.

The insertion or removal of reference electrode 520 may also be done through third opening 514 in the top surface of the chamber 500 by a robotic arm when the sacrificial material has been depleted.

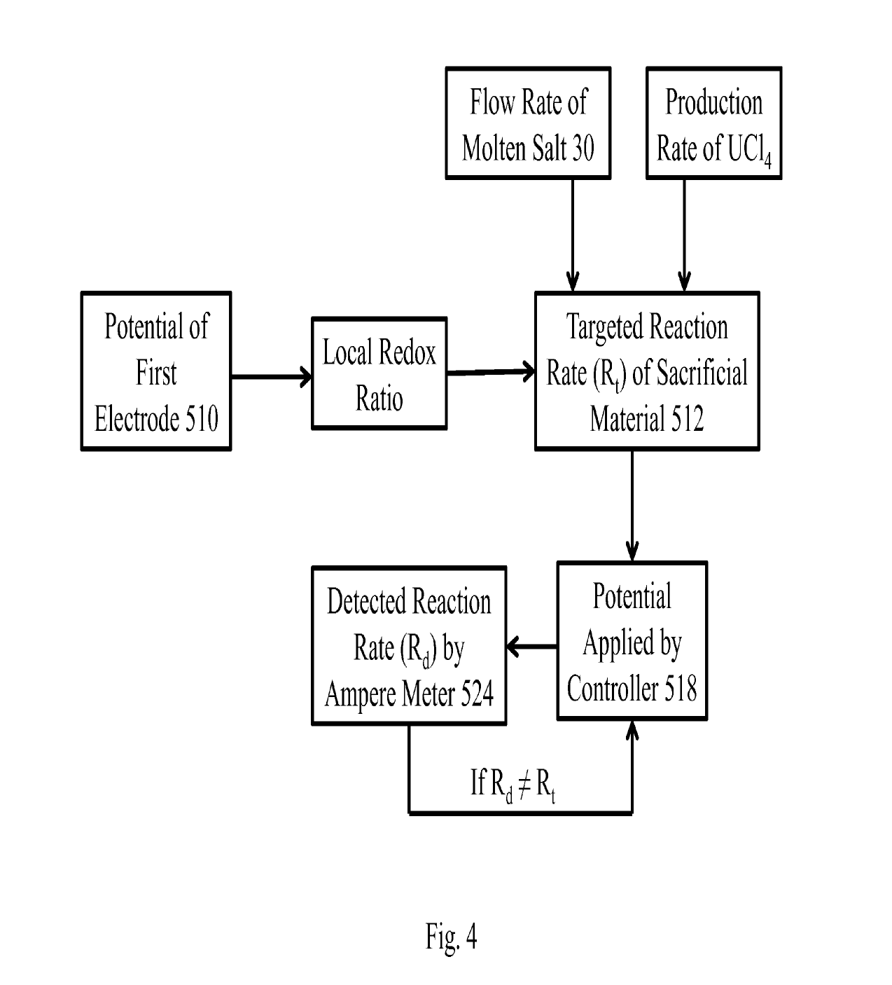

FIG. 4 illustrates the operating mechanism of the corrosion reduction unit 50 in FIG. 3. Upon detection of the potential of the first electrode 510, a local redox ratio (UCl₄/UCl₃) of the molten salt 30 proximate the first electrode 510 is determined based on the detected potential (e.g., using Nernst Equation). A targeted reaction rate (Rₜ) of the sacrificial material 512 (U→U³⁺+3e−) is then determined based on 1) the flow rate of the molten salt 30 (driven by the pump 80); 2) a calculated production rate of UCl₄ in the molten salt 30, and 3) the difference between the detected local redox ratio and the targeted redox ratio in the molten salt reactor 10.

The controller 518 then applies a potential between the first electrode 510 and the second electrode 511 so that the targeted reaction rate of the sacrificial material 512 is achieved on the first electrode 510. The reaction rate (R_{d}) may be detected by the ammeter 524, and the potential applied by the controller 518 is adjustable based on the detected reaction rate. The targeted reaction rate (Rₜ) is established based on the redox ratio (UCl₄/UCl₃) desired in the reactor 10 (e.g. 1/50, 1/2000). The redox ratio desired is then maintained at a constant level by the control system of the corrosion reduction unit 50.

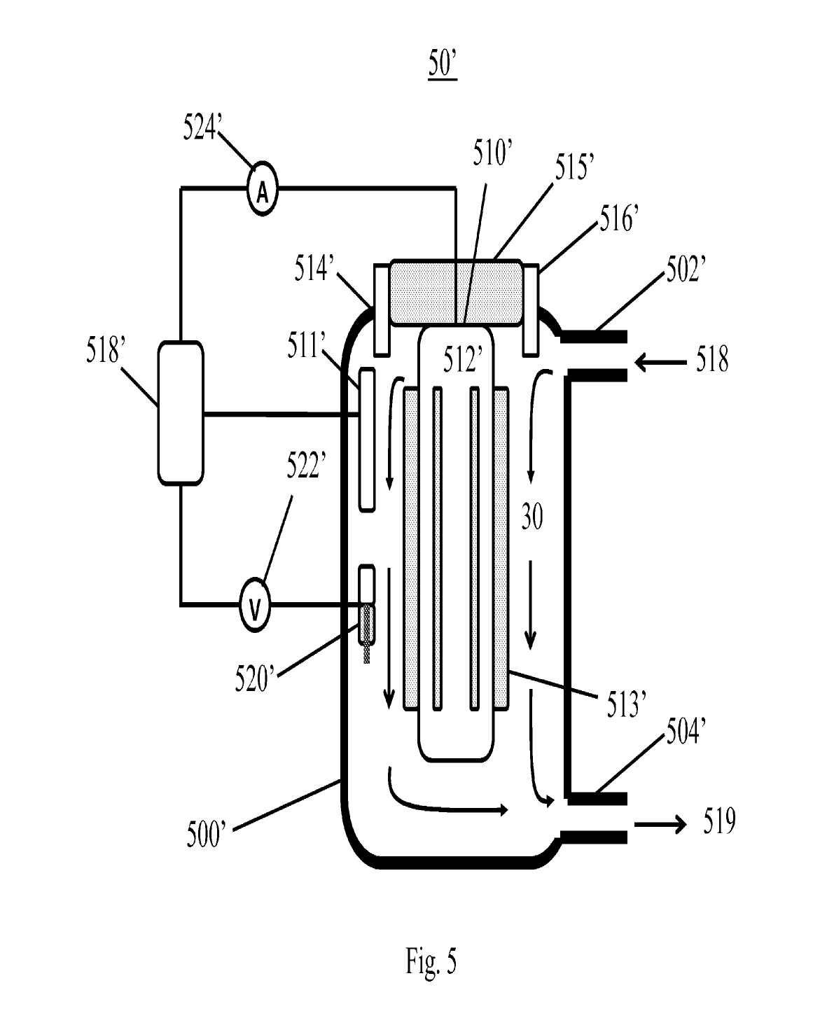

FIG. 5 illustrates an alternative embodiment of the corrosion reduction unit 50′. Instead of using the chamber 500′ as the second electrode, an independent second electrode 511′ is disposed in the chamber 500′. All other components and functionalities are the same as in the corrosion reduction unit 50 described in FIG. 4.

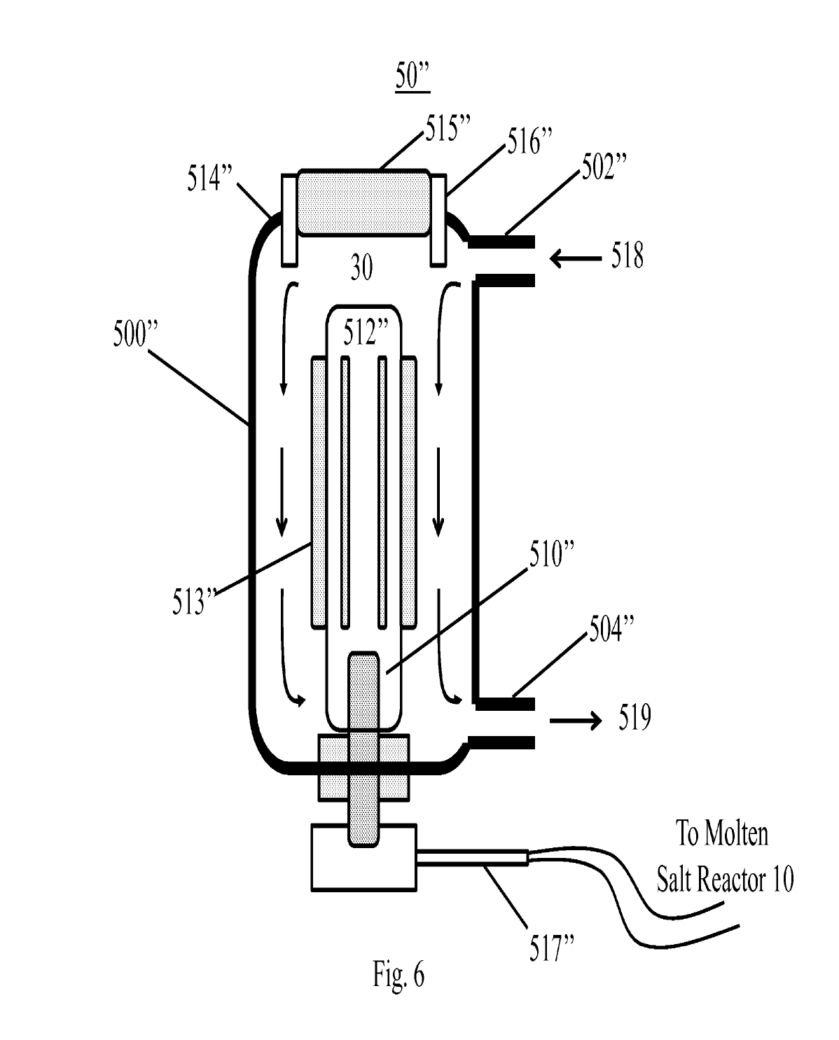

FIG. 6 illustrates yet an alternative embodiment of the corrosion reduction unit 50″. The corrosion reduction unit 50″ includes a chamber 500″ having a first opening 502″ in communication with the molten salt reactor 10, through which the molten salt 30 from the molten salt reactor 10 enters. The chamber 500″ also includes a second opening 504″, through which the molten salt 30 exits the chamber 500″. An electrode 510″ is disposed within the chamber 500″ and electrically connected to the molten salt reactor 10. The electrode 510″ includes a sacrificial material 512″. Upon entering the chamber 500″, the molten salt 30 is in contact with the sacrificial material 512″ and preferably reacts with the sacrificial material 512″. Electrons may travel between the electrode 510″ and the molten salt reactor 10 to reduce the reaction between the molten salt reactor 10 and the molten salt 30.

In this embodiment, the sacrificial material 512″ is an anode composed of uranium (e.g., U-238). During the protection of the molten salt reactor 10, the molten salt 30 preferably oxidizes the uranium in the sacrificial material 512″ (U→U³⁺+3e−; U+3UCl₄→4UCl₃). The oxidation of uranium in the sacrificial material 512″ generates uranium trichloride (UCl₃), which is a soluble and existing substance in the molten salt 30. Electrons generated through the oxidation of the sacrificial material 512″ travel from the electrode 510″ to the molten salt reactor 10 and reduce the oxidation of the molten salt reactor 10 by the molten salt 30, thereby reducing the corrosion of the molten salt reactor 10.

As the sacrificial material 512″ is reacted to generate soluble substances in the molten salt 30 during the protection of the molten salt reactor 10, it may be desirable to replace the electrode 510″ upon consumption of the sacrificial material 512″. The corrosion reduction unit 50″ includes a third opening 514″ having a cover 515″, configured to enable insertion of the electrode 510″ into the chamber 500″ and removal of the electrode 510″ from the chamber 500″. The cover 515″ is preferably constructed with the same material of the chamber 500″. An insulating material 516″ seals the space between the closed cover 515″ and the third opening 514″. The third opening 514″ may be configured to allow access to the electrode 510″ during the nuclear fission with isolation of 50. In this embodiment, the third opening 514″ is disposed on the top surface of the chamber 500″. The insertion or removal of the electrode 510″ may be performed by a robotic arm.

The corrosion reduction unit 50″ includes a conductive lead 517″ to electrically connect the electrode 510″ with the molten salt reactor 10. The conductive lead is connected to the molten salt reactor 10 and provides a path through which electrons travel from the electrode 510″ to the molten salt reactor 10 during the oxidation of the sacrificial material 512″, reducing the corrosion of the molten salt reactor 10 by the molten salt 30. In some embodiments, the lead 517″ may be connected to other parts of the molten salt reactor 10. For example, the lead 517″ may be connected to the chamber 500″, the first line 517 or the second line 518. In alternative embodiments, the electrode 510″ can be directly disposed on an internal surface of the chamber 500″ or an internal surface of the molten salt reactor 10.

As described above, the molten salt reactor 10 may include a metallic alloy. This can include such alloys as chromium (Cr). In some embodiments, the metallic alloy may include iron (Fe), nickel (Ni), manganese (Mn), carbon (C), silicon (Si), niobium (Nb), titanium (Ti), vanadium (V), phosphorus (P), sulfur (S), molybdenum (Mo) or nitrogen (N).

In some embodiments, the sacrificial material 512 may be selected so that the molten salt 30 preferably reacts with the sacrificial material 512. The first electrode 510 may be an anode, and the sacrificial material 512 may be oxidized by the molten salt 30. The sacrificial material 512 may include at least one substance with a lower redox potential than the substances in second electrode 511, so that the molten salt 30 preferably oxidizes the sacrificial material 512. In more preferred embodiments, the sacrificial material 512 may be selected that upon oxidation of the sacrificial material 512, only existing substance in the molten salt 30 may be generated. In more preferred embodiments, the generated substance may be at least one type of actinide.

In some embodiments, the sacrificial material 512 may include at least one type of actinide. As examples, the sacrificial material could include the following actinides: U-232, U-233, U-234, U-235, U-236, U-238, Th-227, Th-228, Th-229, Th-230, Th-231, Th-232, Th-234, Pa-229, Pa-230, Pa-231, Pa-232, Pa-233, Pa-234, as well as Np, Pu, Am, and Cm.

As described above, the actinide in the molten salt 30 may be in an oxidation state of zero or higher, for example, the actinide may be Uranium in an oxidation state of 0, +1, +2, +3, +4, +5, or +6. In certain embodiments, the actinide may be in the form of a salt (e.g., a chloride salt or a fluoride salt).

In some embodiments, the second electrode will be made of steel or some inert metal.

In some embodiments, the reference electrode may be a Standard hydrogen electrode (SHE), a Normal hydrogen electrode (NHE), a Reversible hydrogen electrode (RHE), a Saturated calomel electrode (SCE), a Copper-copper(II) sulfate electrode(CSE), Silver chloride electrode, a pH-electrode, a Palladium-hydrogen electrode, a Dynamic hydrogen electrode (DHE), or a Mercury-mercurous sulfate electrode).

The following are more comprehensive listings of fission products applicable to the present invention. These lists are illustrative and not meant to be exhaustive.

### Fission Products Sufficiently Noble to Maintain a Reduced and Insoluble State in Molten Salt of the Present Invention:

Germanium-72, 73, 74, 76
Arsenic-75
Selenium-77, 78, 79, 80, 82
Yttrium-89
Zirconium-90 to 96
Niobium-95
Molybdenum-95, 97, 98, 100
Technetium-99
Ruthenium-101 to 106
Rhodium-103
Palladium-105 to 110
Silver-109
Cadmium-111 to 116
Indium-115
Tin-117 to 126
Antimony-121, 123, 124, 125
Tellurium-125 to 132
   Fission Products that will Form Gaseous Products at the Operating Temperature of the Present Invention:
Bromine-81
Iodine-127, 129, 131
Xenon-131 to 136
Krypton-83, 84, 85, 86
   Fission Products that will Remain in the Salt as Chloride Compounds in Addition to Actinide Chlorides (Th, Pa, U, Np, Pu, Am, Cm) and Carrier Salt Chlorides(Na, K, Ca) in Connection with the Present Invention:
Rubidium-85, 87
Strontium-88, 89, 90
Caesium-133, 134, 135, 137
Barium-138, 139, 140
Lanthanides (lanthanum-139, cerium-140 to 144, praseodymium-141, 143, neodymium-142 to 146, 148, 150, promethium-147, samarium-149, 151, 152, 154, europium-153, 154, 155, 156, Gadolinium-155 to 160, Terbium-159, 161, and Dysprosium-161)

A number of implementations have been described above. Nevertheless, it will be understood that various modifications may be made. Accordingly, other implementations are within the scope of the following claims.

What is claimed is:

1. A molten salt reactor comprising:
a reactor vessel
a molten salt contained within the reactor vessel; and
a corrosion reduction unit configured to process the molten salt to maintain an oxidation reduction ratio, (E(o)/E(r)), in the molten salt at a substantially constant level, wherein E(o) is an element (E) at a higher oxidation state (o) and E(r) is the element (E) at a lower oxidation state (r).

2. The molten salt reactor of claim 1, wherein the oxidation reduction ratio (E(o)/E(r)) is at a level between 1/20 to 1/2000.

3. The molten salt reactor of claim 1, wherein the corrosion reduction unit comprises:
a chamber having a first opening in communication with the reactor vessel through which the molten salt from the reaction vessel enters the chamber and a second opening through which the molten salt exits the chamber; and
a first electrode disposed within the chamber including a sacrificial material which comprises at least one type of actinide.

4. The molten salt reactor of claim 3, wherein the corrosion reduction unit further comprises:
a second electrode disposed within the chamber that is electrically connected to the first electrode; and
a controller electrically connected to the first and second electrodes to control the potential difference between the first and second electrodes.

5. The molten salt reactor of claim 4, wherein the corrosion reduction unit further comprises a reference electrode in the chamber to detect the potential difference between the first electrode and the molten salt.

6. The molten salt reactor of claim 5, wherein the controller is configured to apply a potential difference between the first electrode and second electrode to maintain the oxidation reduction ratio, (E(o)/E(r)) in the molten salt at the substantially constant level.

7. The molten salt reactor of claim 6, wherein corrosion reduction unit further includes an ammeter connected between the first electrode and the controller to detect a reaction rate of the sacrificial material; wherein the controller is configured compare the detected reaction rate to a target reaction rate and to apply the potential difference between the first electrode and the second electrode based on the comparison of the detected reaction rate to the target reaction rate.

8. The molten salt reactor of claim 3, further comprising:
a first line interconnecting the reactor vessel to the first opening of the chamber; and
a second line interconnecting the second opening of the chamber to the reactor vessel.

9. The molten salt reactor of claim 8, further including a pump to transport the molten salt from the reactor vessel to the chamber through the first line and from the chamber to the reactor vessel through the second line.

10. The molten salt reactor of claim 5, wherein the chamber further comprises a third opening on a top surface of the chamber, the third opening is configured to enable insertion into and removal from the chamber of the first electrode and the reference electrode when replacement is required due to consumption of sacrificial material.

11. A method reducing corrosion in a molten salt reactor comprising:
providing a reactor vessel;
providing a molten salt contained within the reactor vessel; and
processing the molten salt to maintain an oxidation reduction ratio, (E(o)/E(r)), in the molten salt at a substantially constant level, wherein E(o) is an element (E) at a higher oxidation state (o) and E(r) is the element (E) at a lower oxidation state (r).

12. The method of claim 11, wherein the oxidation reduction ratio (E(o)/E(r)) is approximately 1/2000.

13. The method of claim 11, further comprising:
providing a chamber having a first opening in communication with the reactor vessel through which the molten salt from the reaction vessel enters the chamber and a second opening through which the molten salt exits the chamber; and
disposing a first electrode within the chamber including a sacrificial material which comprises at least one type of actinide.

14. The method of claim 13, further comprising:
disposing a second electrode within the chamber that is electrically connected to the first electrode; and
controlling the potential difference between the first and second electrodes.

15. The method of claim 14, further comprising using a reference electrode in the chamber to detect the potential difference between the first electrode and the molten salt.

16. The method of claim 15, wherein the step of controlling includes applying a potential difference between the first electrode and second electrode to maintain the oxidation reduction ratio, (E(o)/E(r)) in the molten salt at the substantially constant level.

17. The method of claim 16, further including providing an ammeter connected between the first electrode and the controller to detect a reaction rate of the sacrificial material; and wherein the step of controlling includes comparing the detected reaction rate to a target reaction rate and applying the potential difference between the first electrode and the second electrode based on the comparison of the detected reaction rate to the target reaction rate.

18. The method of claim 13, further comprising:
interconnecting the reactor vessel to the first opening of the chamber with a first line; and
interconnecting the second opening of the chamber to the reactor vessel with a second line.

19. The method of claim 18, further including pumping the molten salt from the reactor vessel to the chamber through the first line and from the chamber to the reactor vessel through the second line.

20. The method of claim 15, further comprising providing a third opening on a top surface of the chamber and removing from the chamber the first electrode and the reference electrode when replacement is required to due consumption of sacrificial material and inserting a replacement first electrode and a replacement reference electrode.
